(19) United States
(12) Patent Application Publication
(10) Pub. No.: US 2004/0122687 A1
(43) Pub. Date: Jun. 24, 2004

(54) Wireless LAN roaming using a Parlay gateway

(75) Inventors: Thomas E. Creamer, Boca Raton, FL (US); Neil A. Katz, Parkland, FL (US); Victor S. Moore, Boynton Beach, FL (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY

(21) Appl. No.: 10/326,435

(22) Filed: Dec. 19, 2002

(51) Int. Cl. G06F 17/60

(52) U.S. Cl. 705/1

(57) ABSTRACT

A method of providing wireless local area network providers with subscriber administration services can include receiving from a processing node in a wireless local area network a request through a gateway interface for approval for a subscriber to access the wireless local area network. The request can specify subscriber identifying information. A determination can be made as to whether the subscriber is approved to access the wireless local area network using the subscriber identifying information by querying a telecommunications subscriber data store. The processing node of the wireless local area network can be notified of the determination results through the gateway interface. If the subscriber is approved, a record of the wireless session can be stored in a session data store.

### BACKGROUND

1. Field of the Invention

This invention relates to the field of wireless services and, more particularly, to monitoring subscriber usage of wireless local area networks.

2. Description of the Related Art

The use of wireless local area networks (LAN's) has become pervasive. Subscribers often are able to connect to wireless access points provided by various entities as a value added service or as part of the entity's core business model. The increased use of wireless LAN's has led to the development of different technologies which allow subscribers to roam from one wireless LAN to another. Thus, the subscriber is relieved from having to actively terminate a session with a first wireless LAN before establishing a connection with a second wireless LAN as the subscriber moves among coverage zones for different wireless LAN's.

As roaming capabilities of subscribers with respect to wireless LAN's continue to develop, the need for a unified administration system which can provide verification, validation, and billing services has become increasingly apparent. Resources for verification, validation, and billing exist within wireless telecommunications networks. These resources allow service providers, for example cellular service providers and personal communication service (PCS) providers, to track subscriber usage of the wireless network and perform billing functions across different wireless networks as the subscriber roams from one to another. Yet, no comparable solution presently exists for providing administrative functions for wireless LAN's.

More than likely, if service providers do not provide administration services in support of their subscriber base, wireless LAN access providers and other third parties will develop alternate solutions. Because wireless LAN access providers do not have access to the infrastructure in place within the wireless telecommunications network, any solutions developed are not likely to be transparent or unobtrusive to subscribers. Nor are such solutions likely to conform to existing wireless telecommunications verification, validation, and billing standards. In consequence, administration services are likely to be splintered and non-uniform from one wireless LAN to another.

### SUMMARY OF THE INVENTION

The invention disclosed herein provides a solution for performing verification, validation, and billing services for subscribers accessing a wireless local area network (LAN). More particularly, the present invention provides connectivity to a processing node within the wireless LAN so that resources which typically are utilized within a wireless telecommunications network for performing administrative services can be made available to wireless LAN access providers. Thus, the present invention allows wireless LAN systems to work in conjunction with a wireless telecommunication system to provide administrative services as a subscriber roams from one wireless LAN to another. Additionally, because the administrative services described herein incorporate aspects of existing wireless telecommunication resources, the present invention provides a solution which can be adopted and implemented readily by wireless service providers.

One aspect of the present invention can include a method of providing wireless local area network providers with subscriber administration services. The method can include receiving from a processing node in a wireless local area network a request through a gateway interface, such as a Parlay compliant gateway, for approval for a subscriber to access the wireless local area network. The request can specify subscriber identifying information such as a telephone number and/or password. A determination can be made as to whether the subscriber is approved to access the wireless local area network using the subscriber identifying information by querying a telecommunications subscriber data store. For example, the telecommunications subscriber data store can be queried using the telephone number for the subscriber. The telecommunications subscriber data store can be a Home Location Register and/or a Visitor Location Register.

The processing node of the wireless local area network can be notified of the determination results through the gateway interface. If the subscriber is approved, a record of the wireless session can be stored in a session data store. For example, a time the wireless session started can be recorded in the session data store. Additionally, when a notification is received which indicates that the wireless session has terminated, a time when the wireless session terminated can be recorded in the session data store.

Another aspect of the present invention can include a method of performing subscriber administration services within a wireless local area network. The method can include receiving from a wireless device a request for connecting to the wireless local area network. The request can specify identifying information associated with a subscriber using the wireless device. The identifying information can be sent over a gateway interface, such as a Parlay compliant gateway, to a wireless telecommunications resource for performing subscriber validation and verification. The wireless telecommunications resource can be a Home Location Register and/or a Visitor Location Register. A response can be received which indicates whether the subscriber request has been approved. The response also can be received via the gateway interface. The wireless device can be granted access to the wireless local area network according to the received response.

Another aspect of the present invention can include a system for monitoring usage of wireless resources by subscribers. The system can include a wireless application server configured to authenticate subscribers with one or more telecommunications data stores. A gateway having a wireless service object executing therein can be included. The wireless service object can be configured to communicate with a node of a wireless local area network and the wireless application server.

The wireless application server can include a session application configured to validate and verify subscribers with the one or more telecommunications data stores. For example, the telecommunications data stores can include a Home Location Register and/or a Visiting Location Register. A session data store can be included wherein the session application is configured to store wireless local area network session data for subscribers within the session data store. The wireless application server also can include a billing application configured to provide the wireless local area network data to a billing system.

The system can include a wireless local area network having at least one node configured to communicate with the gateway. The node can be an authentication server having a client executing therein for communicating with the gateway. The client can be a Parlay compliant client and the gateway can be a Parlay compliant gateway. The system also can include an authorization gateway configured to communicate with at least one wireless access point and the authentication server.

Another aspect of the present invention can include a wireless local area network configured to monitor subscriber usage. The wireless local area network can include an authentication server having a gateway client executing therein for communicating with a gateway for performing subscriber validation and verification using a wireless telecommunications resource and one or more wireless access points for establishing wireless communications with a wireless device. The system further can include an authorization gateway configured to communicate with the one or more wireless access points and the authentication server, as well as grant access to the wireless device responsive to communications received from the authentication server through the gateway client. Notably, the gateway client can be implemented as a Parlay compliant client and the authentication server can be implemented as a Remote Authentication Dial-In User Service compliant server.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for performing administration services for wireless local area networks in accordance with the inventive arrangements disclosed herein.

FIGS. 2A and 2B, taken together, are segments of a flow chart illustrating a method for performing administration services using the system of FIG. 1.

### DETAILED DESCRIPTION OF THE INVENTION

The invention disclosed herein provides a method, system, and apparatus for performing administrative services such as verification, validation, and billing for subscribers accessing a wireless local area network (LAN). The present invention facilitates the connection of a processing node within the wireless LAN to resources within a wireless telecommunications network. Accordingly, a wireless LAN access provider can utilize wireless telecommunications resources for purposes of verification, validation, and billing.

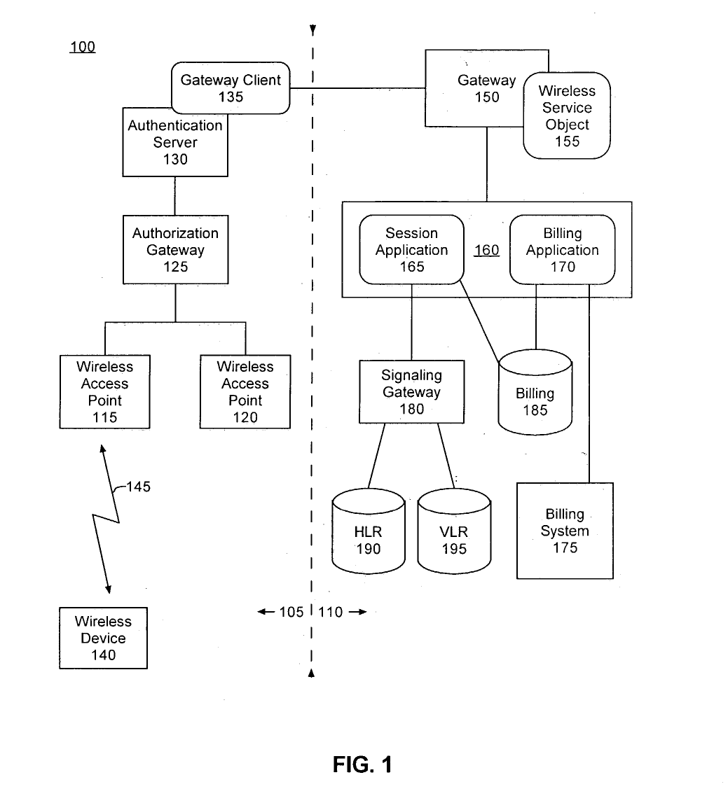

FIG. 1 is a schematic diagram illustrating a system 100 for performing administration services for wireless local area networks in accordance with the inventive arrangements disclosed herein. As shown in FIG. 1, the system 100 can include a wireless LAN 105 and a telecommunications system 110. The wireless LAN 105 can include one or more wireless access points (WAP's) 115 and 120, an authorization gateway 125, and an authentication server 130.

The WAP's 115 and 120 can provide wireless connectivity to one or more wireless devices such as wireless device 140. The WAP's 115 and 120 can send and receive packetized information over a short range wireless communications link. For example, according to one embodiment of the present invention, the WAP's 115 and 120 can provide wireless connectivity using Bluetooth or one of the communications protocols from the 802.11 family of wireless communications protocols such as 802.11a or 802.11b. The present invention, however, is not limited to the use of one particular communications protocol. Rather, any existing or emerging short range wireless communications technology can be used to provide wireless connectivity from the WAP's 115 and 120 to the wireless device 140.

The authorization gateway 125 can be a server communicatively linked to each of the WAP's 115 and 120. The authorization gateway 125 can maintain a listing of known or authorized subscribers as well as store information indicating the particular WAP to which a subscriber using a wireless device has established a connection. The authentication server 130 can communicate with another central information processing system to authenticate subscribers. For example, the authentication server 130 can be a Remote Authentication Dial-In User Service (RADIUS) compliant server capable of authenticating subscribers and authorizing subscribers to access the wireless LAN 105. The authentication server 130 also can include a gateway client 135 for communicating with the gateway 150. For example, according to one embodiment of the present invention, the gateway client 135 can be a Parlay client executing in the authentication server 130.

In operation, a subscriber can utilize a wireless device 140 and establish a wireless communications link 145 with either the WAP 115 or the WAP 120. As used herein, the term “wireless device” can include any device capable of establishing a short range wireless communications link with the WAP's 115 and/or 120. Thus, the wireless device 140 can be a portable computer, a personal digital assistant, or other data appliance having wireless capabilities.

Accordingly, the authorization gateway 125 can receive communications forwarded from the WAP 115 with which the wireless device 140 has established the wireless communications link 145. The authorization gateway 125 can determine whether the subscriber is known. If the subscriber is not known, the authorization gateway 125 can query the subscriber for identifying information which, once obtained from the subscriber, can be provided to the authentication server 130. The authentication server 130, and more particularly the gateway client 135, can send a query to the telecommunications system 110 so that the subscriber can be validated and verified and so that billing for an as of yet unestablished wireless session can be performed.

The telecommunications system 1 10 can include a gateway 150, a wireless application server 160, a billing system 175, a signaling gateway 180, and one or more, telecommunications subscriber data stores 185, 190, and 195. The gateway 150 can be implemented as a Parlay compliant gateway. Parlay specifies an open application programming interface (API) for managing network “edge” services. The Parlay specification supports cross-platform network applications and provides open application programming interfaces (API's) for functions such as authentication, event notification, mobility, charging and billing, and subscriber data.

The gateway 150 also can include a wireless service object 155. The wireless service object 155 can be a program configured to execute within the gateway 150 and can be configured to communicate with and serve as an interface to the wireless application server 160. The wireless application server 160 can host two applications, a session application 165 and a billing application 170.

The session application 165 can access one or more telecommunications data stores for performing subscriber validation and verification. For example, the session application 165 can be configured to issue Mobile Application Part (MAP) ANSI 41 queries to the Home Location Register (HLR) 190 and Visitor Location Register (VLR) 195 resources. The session application 165 also can receive events from the wireless LAN indicating that a subscriber wireless LAN session has been established and that the subscriber wireless LAN session has terminated. The timing information of the session, and particularly the start and stop times of the subscriber's wireless LAN session, can be stored as an entry by the session application within the session data store 185.

The billing application 185 can read billing records stored in the session data store 185 and provide the records to the billing system 175. The billing system 175 can be another information processing system which can bill particular subscriber accounts in accordance with the billing records stored in the session data store 185. Notably, the billing application 170 can read the session data store and provide billing records from the session data store 185 to the billing system 175 from time to time or upon request of the billing system 175.

The signaling gateway 180 can serve as an interface between the wireless application server 160, and more particularly the session application 165, and various resources within the wireless telecommunications network. Through the signaling gateway 180, the session application 165 can query the HLR 190 and/or the VLR 195 to perform verification and validation functions.

In operation, verification and validation requests received from the wireless LAN 105 via the gateway client 135 can be received by the gateway 150. The wireless service object 155 can detect and identify such requests and provide the request to the wireless application server 160. Accordingly, the session application 165 can receive the query, and in turn, query the wireless telecommunications data stores 190 and/or 195 via the signaling gateway 180 to perform verification and validation for the subscriber attempting to gain access to the wireless LAN 105.

More particularly, the session application 165 can query the HLR 190. The HLR 190 is a processing node having a database which stores subscriber data. The HLR stores permanent data about subscribers, including a subscriber's service profile, location information, and activity status. For example, when a subscriber purchases a subscription from a wireless service provider, the subscriber is registered in the HLR of the wireless service provider.

Similarly, the session application 165 can query the VLR 195. The VLR 195 is a processing node having subscriber information similar to the HLR 190. Notably, the VLR 195, in providing support to a mobile service switching center (MSC—not shown), can request subscriber data for a mobile subscriber which roams into a new MSC area. The VLR which is connected to the MSC can request subscriber information regarding the detected mobile subscriber from the HLR 190.

The session application 165, upon receiving identifying subscriber information such as a telephone number and/or password, can determine whether the subscriber is located within the subscriber's home area. If so, the session application 165 can query the HLR 190 for subscriber validation and verification. If the subscriber is not located in a home area, the VLR 195 can be queried which in turn can query the HLR corresponding to the home area of the subscriber for subscriber information. The VLR 195, upon receiving requested subscriber information can provide the information to the session application 165 for purposes of verification and validation.

If the subscriber has been verified and validated, the session application 165 can make an entry in the session data store 185 indicating the time the subscriber's wireless LAN session began. Similarly, upon receiving a termination event or message from the wireless LAN 105, the session application 165 can make another entry in the session data store 185 indicating the time the subscriber's wireless LAN session terminated. As noted, from time to time, or upon request of the billing system 175, the billing application 170 can retrieve the billing data regarding the subscriber's wireless LAN session from the session data store 185 and provide the billing data to the billing system 175.

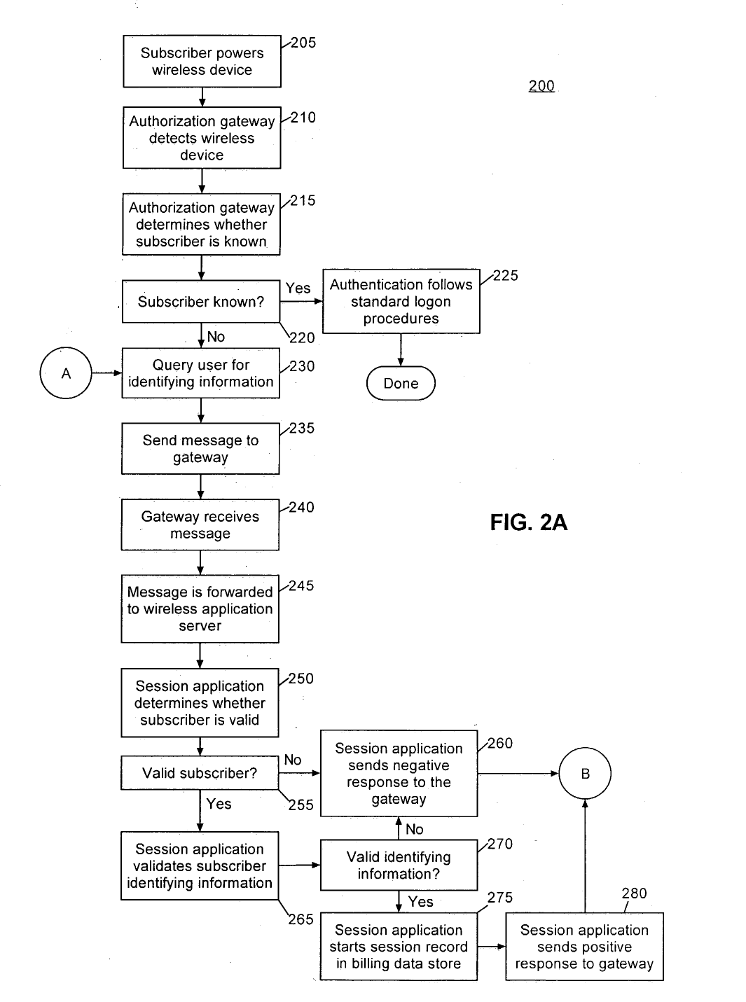

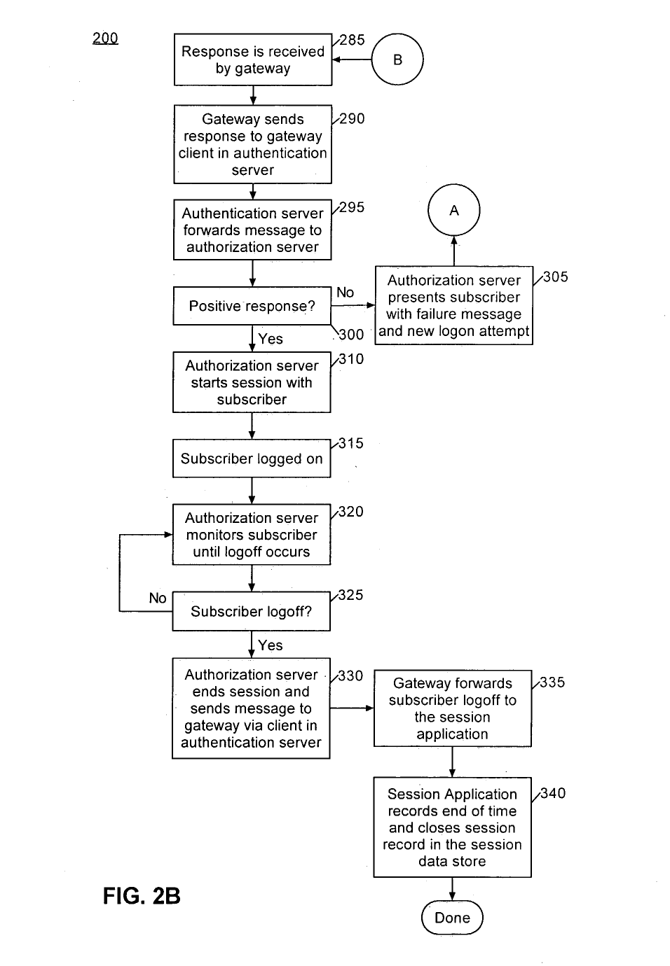

FIGS. 2A and 2B, taken together, are segments of a flow chart illustrating a method 200 for performing verification, validation, and billing services using the system of FIG. 1. The method 200 can begin in FIG. 2A in step 205 where a subscriber can power on a wireless device. In step 210, the authorization gateway can detect the subscriber's wireless device. For example, the wireless device, when in range of a WAP of the wireless LAN, can be detected by the WAP which can signal the authorization gateway that a wireless device has been detected.

In step 215, the authorization gateway can determine whether the subscriber is known. The authorization gateway can store a listing of subscriber profiles for subscribers which have been registered with the authorization gateway. For example, local subscribers or subscribers who utilize a particular wireless LAN on an occasional or frequent basis can choose to register with the authorization gateway to facilitate faster connections. Such subscribers can be considered known or require no further verification or validation using telecommunications resources. Thus, if the subscriber is known in step 220, the method can proceed to step 225, where the authentication can follow a standard logon type of procedure. For example, such an authentication procedure can include a username and/or password. After step 225, the method can end. Still, the method 200 can be repeated as necessary to process additional subscriber requests for wireless LAN access.

If, however, in step 220 a determination is made that the subscriber is unknown, the method can proceed to step 230. In step 230, the authentication server can query the subscriber for additional information. For example, the authentication server can request that the subscriber enter a telephone number such as a wireless telephone number, a home telephone number, a password, or any other identifying information which can be used to perform verification and validation using wireless telecommunications resources as described herein.

In step 235, the authorization server can send a message to the gateway. That is, the authorization server can send a message via the authentication server and gateway client to the gateway. In step 240, the gateway can receive the message. Notably, the wireless service object can identify the received message as one which is to be directed to the wireless application server. Accordingly, in step 245, the wireless service object can forward the message to the session application within the wireless application server.

In step 250, the session application can determine whether the subscriber is valid based upon the identifying information provided by the subscriber. For example, the session application, using subscriber provided identifying information such as the telephone number, can determine whether to query the HLR or the VLR. In any case, regardless of which register is queried, the session application can utilize the MAP ANSI 41 interface to query whether the subscriber is a valid subscriber, that is whether the subscriber has been registered or an entry exists for the subscriber. If a determination is made in step 255 that the subscriber is valid, the method can proceed to step 265. If, in step 255, a determination is made that the subscriber is not valid, the method can proceed to step 260. In step 260, the session application can send a negative response to the gateway. From step 260, the method can proceed to jump circle B.

Continuing with step 265, the session application can validate the subscriber provided identifying information. More particularly, the subscriber provided telephone number, password, and any other subscriber provided identifying information can be validated against information retrieved from the HLR or VLR query. In step 270, a determination can be made as to whether the subscriber provided information is valid. If so, the method can proceed to step 275 where the session application can begin a session record in the session data store. For example, the session application can make an entry which indicates the time corresponding to the start of a wireless session for the requesting subscriber. In step 280, the session application can send a positive response to the gateway. The method then can proceed to jump circle B.

In FIG. 2B, proceeding from jump circle B, the method can proceed to step 285 where the gateway can receive the response whether positive or negative. In step 290, the gateway can send the response to the gateway client in the authentication server. The authentication server then can forward the message to the authorization server in step 295. In step 300, a determination can be made as to whether the response was positive or negative. If the response was negative, the method can proceed to step 305, where the authorization server can present the subscriber with a failure message and a new logon attempt. Thus, the method can proceed to jump circle A and on to step 230 to query the subscriber for identifying information and repeat as necessary.

If the response was positive, the method can proceed to step 310 where the authorization gateway can begin the session with the subscriber. Accordingly, in step 315 the subscriber is logged onto the wireless LAN and as such the subscriber can be granted access to public and/or private networks (not shown) as the case may be. In step 320, the authentication gateway can begin monitoring the subscriber's activities to determine when the subscriber logs off from the wireless LAN. Accordingly, the method can continually loop through steps 320 and 325 until such time when the subscriber does terminate the wireless LAN session.

When the authorization gateway detects that the subscriber has terminated the wireless LAN session, in step 330, the authorization gateway can terminate the wireless session and send a message to the gateway via the authorization server and gateway client executing therein. The termination message or subscriber logoff message can indicate a time when the subscriber terminated the wireless LAN session or a time when the termination was detected, for example by the authorization gateway. Thus, in step 335, the gateway can forward the subscriber logoff information to the session application. In step 340, the session application can record the session end time. The wireless LAN session end time can be determined from the received logoff message or from an internal timekeeping mechanism which can be read or measured when the session application receives the subscriber logoff message. Regardless, the session application 340 can record the subscriber's wireless LAN session termination time and close the entry in the session data store. The method then can end or repeat to process further subscriber requests for network access as may be required.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of providing wireless local area network providers with subscriber administration services comprising:
receiving from a processing node in a wireless local area network a request through a gateway interface for approval for a subscriber to access the wireless local area network, wherein the request specifies subscriber identifying information;
determining whether the subscriber is approved to access the wireless local area network using the subscriber identifying information by querying a telecommunications subscriber data store;
notifying the processing node of the wireless local area network of the determination results through the gateway interface; and
if the subscriber is approved, storing a record of the wireless session in a session data store.

2. The method of claim 1, wherein the gateway interface is a Parlay compliant gateway.

3. The method of claim 1, wherein the subscriber identifying information comprises a telephone number and a subscriber password.

4. The method of claim 1, said step of storing a record further comprising:
recording in the session data store a time the wireless session started;
receiving a notification that the wireless session has terminated; and
recording in the session data store a time the wireless session terminated.

5. The method of claim 1, wherein the subscriber identifying information includes at least a telephone number for the subscriber, said determining step further comprising:
querying the telecommunications subscriber data store using the telephone number for the subscriber, wherein the telecommunications subscriber data store is selected from the group consisting of a Home Location Register or a Visitor Location Register.

6. Within a wireless local area network, a method of performing subscriber administration services comprising:
receiving from a wireless device a request for connecting to the wireless local area network, wherein the request specifies identifying information associated with a subscriber using the wireless device;
sending the identifying information over a gateway interface to a wireless telecommunications resource for performing subscriber validation and verification;
receiving a response indicating whether the subscriber request has been approved, wherein the response is received via the gateway interface; and
granting the wireless device access to the wireless local area network according to the received response.

7. The method of claim 6, wherein the gateway interface is a Parlay compliant gateway interface.

8. The method of claim 6, wherein the wireless telecommunications resource is selected from the group consisting of a Home Location Register and a Visitor Location Register.

9. A system for monitoring usage of wireless resources by subscribers comprising:
a wireless application server configured to authenticate subscribers with at least one telecommunications data store; and
a gateway having a wireless service object executing therein, wherein said wireless service object is configured to communicate with a node of a wireless local area network and said wireless application server

10. The system of claim 9, wherein said wireless application server includes a session application configured to authenticate subscribers with the at least one telecommunications data store, wherein the at least one telecommunications data store is selected form the group consisting of a Home Location Register and a Visiting Location Register.

11. The system of claim 9, further comprising:
a session data store, wherein said session application is configured to store wireless local area network session data for subscribers within said session data store.

12. The system of claim 11, wherein said wireless application server includes a billing application configured to provide the wireless local area network data to a billing system.

13. The system of claim 9, further comprising:
a wireless local area network having at least one node configured to communicate with said gateway.

14. The system of claim 13, wherein said node configured to communicate with said gateway is an authentication server having a client executing therein for communicating with said gateway.

15. The system of claim 14, wherein said client of said authentication server is a Parlay compliant client and said gateway is a Parlay compliant gateway.

16. The system of claim 14, further comprising:
an authorization gateway configured to communicate with at least one wireless access point and said authentication server.

17. A wireless local area network configured to monitor subscriber usage comprising:
an authentication server having a gateway client executing therein for communicating with a gateway for performing subscriber validation and verification using a wireless telecommunication's resource;
at least one wireless access point for establishing wireless communications with a wireless device; and
an authorization gateway configured to communicate with the at least one wireless access point and said authentication server and grant access to the wireless device responsive to communications received from said authentication server through said gateway client.

18. The system of claim 17, wherein said gateway client is a Parlay compliant client.

19. The system of claim 18, wherein said authentication server is a Remote Authentication Dial-In User Service compliant server.

20. A machine readable storage, having stored thereon a computer program having a plurality of code sections executable by a machine for causing the machine to perform the steps of:
receiving from a processing node in a wireless local area network a request through a gateway interface for approval for a subscriber to access the wireless local area network, wherein the request specifies subscriber identifying information;
determining whether the subscriber is approved to access the wireless local area network using the subscriber identifying information by querying a telecommunications subscriber data store;
notifying the processing node of the wireless local area network of the determination results through the gateway interface; and
if the subscriber is approved, storing a record of the wireless session in a session data store.

21. The machine readable storage of claim 20, wherein the gateway interface is a Parlay compliant gateway.

22. The machine readable storage of claim 20, wherein the subscriber identifying information comprises a telephone number and a subscriber password.

23. The machine readable storage of claim 20, said step of storing a record further comprising:
recording in the session data store a time the wireless session started;
receiving a notification that the wireless session has terminated; and
recording in the session data store a time the wireless session terminated.

24. The machine readable storage of claim 20, wherein the subscriber identifying information includes at least a telephone number for the subscriber, said determining step further comprising:
querying the telecommunications subscriber data store using the telephone number for the subscriber, wherein the telecommunications subscriber data store is selected from the group consisting of a Home Location Register or a Visitor Location Register.

25. A machine readable storage, having stored thereon a computer program having a plurality of code sections executable by a machine for causing the machine to perform the steps of:
receiving from a wireless device a request for connecting to the wireless local area network, wherein the request specifies identifying information associated with a subscriber using the wireless device;
sending the identifying information over a gateway interface to a wireless telecommunications resource for performing subscriber validation and verification;
receiving a response indicating whether the subscriber request has been approved, wherein the response is received via the gateway interface; and
granting the wireless device access to the wireless local area network according to the received response.

26. The machine readable storage of claim 25, wherein the gateway interface is a Parlay compliant gateway interface.

27. The machine readable storage of claim 25, wherein the wireless telecommunications resource is selected from the group consisting of a Home Location Register and a Visitor Location Register.
